(19) United States
(12) Patent Application Publication
(10) Pub. No.: US 2022/0025943 A1
(43) Pub. Date: Jan. 27, 2022

(54) DETERMINING THE ENGAGEMENT POINT OF A CLUTCH

(71) Applicant: ZF Friedrichshafen AG, Friedrichshafen (DE)

(72) Inventors: Marcus GANSOHR, Salem (DE); Manuel SCHNEIDER, Horgenzell (DE); Marco WAGEGG, Leutkirch im Allgäu (DE)

(21) Appl. No.: 17/311,045

(22) PCT Filed: Dec. 5, 2019
(86) PCT No.: PCT/EP2019/083792

§ 371 Date: Jun. 4, 2021

(51) Int. Cl. F16D 48/06

(52) U.S. Cl. CPC F16D 48/06; F16D 2500/10412; F16D 2500/1045; F16D 2500/30415; F16D 2500/50266; F16D 2500/3127; F16D 2500/1064

(57) ABSTRACT

A method for determining an engagement point (X) of a clutch (3). The clutch (3) has first and second clutch sides (3a, 3b), which are rotationally decoupled when the clutch (3) is disengaged/open and which are rotationally coupled when the clutch (3) is engaged/closed. The method includes the steps of disengaging the clutch (3) and then engaging the clutch (3), in order to determine the engagement point (X). During this, the first clutch side (3a) is driven in rotation and the second clutch side (3b) is accelerated, for at least part of the time, by an acceleration device (4). A control device actuates the clutch (3) in order determine the engagement point (X) of the clutch (3), and a computer program product with stored commands, brings about the sequence of the method when the program is operated on a suitable control unit.

This application is a National Stage completion of PCT/EP2019/083792 filed Dec. 5, 2019, which claims priority from German patent application serial no. 10 2018 221 532.4 filed Dec. 12, 2018.

### FIELD OF THE INVENTION

The invention relates to a method for determining an engagement point of a clutch, in particular a frictional clutch. It also relates to a control unit designed for the purpose and to a computer program product with commands for carrying out the method.

### BACKGROUND OF THE INVENTION

Clutches are known which are actuated automatically, i.e. opened and closed by a clutch actuator, for example in automatic or automated motor vehicle transmissions. For the automatic actuation of a clutch, knowledge of the so-termed engagement point of the clutch is of prime importance. The engagement point is understood to mean that clutch position at which the clutch components of the clutch that can be coupled with one another are only just in contact with one another without the clutch transmitting any appreciable force. In other words, the clutch components are positioned immediately before the point where they are able to engage. This applies to interlocking clutches as well as to frictional clutches. If the engagement point is known, the clutch can be actuated in a targeted and precise manner.

However the engagement point of a clutch varies, in particular because of component tolerances and clutch wear. Accordingly, for automatic clutches procedures are known for determining the individual engagement point of such a clutch. This is often also known as ‘learning’ the engagement point.

EP 2 478 248 B1 describes such a procedure for determining the engagement point of a clutch of a vehicle, in this case called the contact point. The engagement point is determined with reference to the torque transmitted by the clutch. The torque transmitted is estimated with reference to an angular velocity and an angular acceleration of a transmission component coupled to the clutch. This known procedure provides first for an acceleration of a first transmission component and subsequently for an estimation of a friction torque for the first transmission component. The acceleration of the first transmission component takes place due to a brief closing and re-opening of the clutch after initiating the determination process, in order to produce a particular rotational speed at the first transmission component (see FIGS. 4 and 5 of EP 2 478 248 B1). Thus, the starting point of this procedure is the open clutch.

DE 10 2008 042 891 A1 also describes a procedure for determining the engagement point of a clutch of a vehicle, in this case called the touch-point. In this, an environment and/or condition parameter that influences the touch-point to be detected is taken into account.

Not every procedure for determining the engagement point is suitable for any installation position, structure and operating method of an automatic clutch. With certain clutch structures at least one side of the clutch can be moved axially within limits. This is often so with friction-disk clutches, in which when the clutch is open the clutch disk can move slightly along the rotational axis, i.e. axially. Thus, when a clutch of this type is in a suitable position, then when the clutch is open the clutch disk can be displaced slightly. Such a movement can also be caused by vibrations or other external influences—even when the clutch is positioned horizontally. When the clutch is closed, as soon as the clutch disk comes into contact with the other side of the clutch a certain amount of force can be transmitted between the sides of the clutch, and this without the clutch having reached its actual engagement point. If that happens during the ‘learning’ of the engagement point, there is a risk that the engagement point will be determined erroneously. The result of this is that the clutch cannot be operated automatically in the correct manner. That happens in particular with clutches connected upstream from a transmission with low internal friction torques (=drag torques).

### SUMMARY OF THE INVENTION

The purpose of the present invention is to develop the prior art further, with regard to these problems.

This objective is achieved by the features specified in the principal claim. Preferred embodiments emerge from the subordinate claims.

According to these, a method and a control unit and a computer program product are proposed, each respectively designed to determine the engagement point of a clutch. The clutch has a first and a second clutch side. When the clutch is open these two clutch sides are rotationally decoupled from one another, i.e. they can rotate relative to one another, but when the clutch is closed they are rotationally coupled, i.e. they can only rotate together with one another. In particular the clutch is a frictional clutch. However, it is possible in principle for the clutch to be of the interlocking type. In particular the clutch is actuated automatically. Accordingly, the proposed method proceeds in particular automatically, so no intervention by a user is provided for or necessary.

In the proposed method, the clutch is first opened and then closed again in order to determine the engagement point. During this process it is proposed that the first clutch side is driven in rotation. In addition it is proposed that during this process the second clutch side is accelerated by means of an acceleration device, at least for a time. The starting point for the method is thus in particular the closed clutch.

The selective acceleration of the second clutch side by means of the acceleration device prevents the second clutch side from inadvertently moving axially during the determination of the engagement point. This is because the acceleration increases the frictional forces within and in the area of the second clutch side, which prevents or at least sufficiently delays the undesired axial movement. Thus, during the determination of the engagement point, the second clutch side is axially fixed for a sufficiently long time for the engagement point to be determined correctly. The proposed method can therefore be used particularly advantageously with a clutch connected upstream from a transmission with a low drag torque. Due to the low drag torque, the second clutch side, which is associated with the transmission, is hardly at all braked by it. Without the selective acceleration by means of the acceleration device, in such a case the second clutch side could be displaced axially particularly easily, which is undesirable.

In particular, in the clutch the second clutch side is designed to move in the axial direction when the clutch is open, at least within certain limits. For example the second clutch side can be arranged with its clutch hub on a shaft, axially movably but in a rotationally fixed manner. In the clutch at least one of the two clutch sides can be in the form of a clutch disk, preferably the second clutch side. The other one of the two clutch sides, preferably the first clutch side, can be in the form of a pressure plate.

It is not imperatively necessary for the second clutch side to be accelerated by the acceleration device throughout the process of opening and then closing the clutch. Namely, due to the inertial mass of the second clutch side it can be sufficient for the second clutch side to be accelerated only during a time which is shorter than the total time interval between opening the clutch and closing it as far as the engagement point. The more rapidly the determination of the engagement point takes place, the shorter can be the time during which the second clutch side is accelerated.

In particular, it is provided that the acceleration of the second clutch side by the acceleration device, viewed from the time perspective, begins either during or after the opening of the clutch and then ends already before the closing of the frictional clutch, or ends only during the closing of the frictional clutch. When the acceleration device has a long reaction time, i.e. it reacts relatively inertly, the acceleration of the second clutch side preferably begins already during the opening of the clutch. On the other hand, if the reaction time is short, the acceleration of the second clutch side preferably begins shortly before, or only when the clutch is opened. The acceleration of the second clutch side by the acceleration device preferably ends before the (complete) closing of the cutch, in order to avoid greater wear of the clutch and/or of the acceleration device. Thus, the acceleration of the second clutch side by the acceleration device preferably already ends before the engagement point has been reached. By an appropriate choice of the beginning and end times of the acceleration of the second clutch side, the time lag of the acceleration device can be compensated for.

The first clutch side is driven, in particular continuously, during the opening and subsequent closing of the clutch, in particular with a constant and predetermined rotational speed.

In the context of the proposed method, the clutch is, in particular, initially fully opened. The clutch is in particular fully closed after opening in the context of the proposed method. However, the latter does not necessarily have to be the case since basically the clutch only has to be closed until the engagement point has been determined. In the case of a frictional clutch, this normally takes place substantially before complete closing. Accordingly, in the context of the proposed method it can also be provided that the clutch is only partially closed—i.e. not as late as complete closure.

During acceleration of the second clutch side, the acceleration device can either increase or decrease a rotational speed of the second clutch side. Thus, the acceleration of the second clutch side can be positive, for which purpose the second clutch side is driven by means of the acceleration device in a targeted manner. Or instead, the acceleration of the second clutch side can be negative, for which purpose the second clutch side is braked by means of the acceleration device in a targeted manner. The braking of the second clutch side preferably takes place by using existing drive-train components as the acceleration device. In particular, the acceleration device is designed to be switchable. Thus, in the switched-on condition the second clutch side can be selectively accelerated whereas in the switched-off condition this is not possible.

If the second clutch side is braked in order to determine the engagement point, then preferably before the clutch is opened the second clutch side, together with the first clutch side, are brought to the same rotational speed, preferably a predetermined rotational speed. This takes place by driving the first clutch side while the clutch is closed. After opening the clutch, the second clutch side then preferably continues rotating freely until it is braked by the acceleration device. During this the first clutch side continues being driven. The time interval between opening the clutch and the braking of the second clutch side is as short as possible in order to avoid the aforesaid undesired axial movement of the second clutch side.

Particularly preferably, the clutch is a frictional clutch for a motor vehicle, especially a utility vehicle. The frictional clutch can be a starting clutch of the motor vehicle. However, the frictional clutch can also be a converter bridging clutch for a motor vehicle. This frictional clutch is designed to be drive-technically connected between a drive motor (especially an internal combustion engine) of the motor vehicle on one side and a transmission (especially a multi-stage transmission) of the motor vehicle on the other side. In the installed condition, therefore, the first clutch side is associated with the drive motor and is connected rotationally fixed to its driveshaft. The second clutch side is then associated with the transmission and coupled rotationally fixed to its drive input shaft. Thus, the clutch is connected upstream from the transmission. In particular, the clutch is designed to be arranged in a clutch bell of the transmission. The transmission is preferably an automated change-speed transmission or an automatic transmission. Thus, the clutch serves for the optional drive-technical separation and coupling of the drive motor and the transmission input.

During the proposed method for determining the engagement point, the transmission is in particular in an idling condition, i.e. no gear step of the transmission is engaged and any driving connection between the input shaft of the transmission and an output shaft of the transmission is interrupted. The second clutch side can therefore rotate freely, at least until it is accelerated by the acceleration device.

In particular, the drive motor, the transmission and the clutch are designed such that in the installed condition they are in an inclined position relative to a road surface on which the motor vehicle is standing. When the motor vehicle is on a horizontal road surface, at least the components of the drive-train are therefore inclined away from the horizontal. Such an arrangement of the components can simplify the drive-train of the motor vehicle. As already explained earlier, an undesired axial movement of the second clutch side during the determination of the engagement point is prevented by virtue of the proposed acceleration of the second clutch side by means of the acceleration device.

Preferably, as the acceleration device a drive-train component is used, which is drive-technically coupled to the second clutch side and which has some primary purpose other than to accelerate the second clutch side. The acceleration of the second clutch side is then only a secondary purpose. Such a drive-train component is therefore in any case already present in the drive-train. Accordingly, the engagement point can be determined with existing means. The proposed method can thus be used in a simple manner with already existing drive-trains.

Preferably, the acceleration device is a synchronizing device of the transmission for synchronizing at least one shifting element of the transmission. Such a shifting element can serve to shift at least one of the plurality of gear steps of the transmission. Such synchronizing devices are always present in synchronized change-speed transmissions.

The synchronizing device can be a transmission brake. Such a transmission brake serves primarily to brake a shaft of the transmission that is drive-technically coupled to the second clutch side in order to synchronize the transmission. The transmission brake can for example act to brake a countershaft of the transmission. Thus, to brake the second clutch side the transmission brake is used.

The synchronizing device can also be in the form of one or more synchronizing rings of the shifting element. Such synchronizing rings are usually present in any case in synchronized change-speed transmissions. Thus, to brake the second clutch side the shifting element is then actuated in such manner that the synchronizing ring or rings come into frictional contact with the counterpart concerned and therefore exert a braking action upon the second clutch side.

However, the accelerating device can also be an electric traction machine for driving the motor vehicle, for example a synchronous machine or an asynchronous machine. The traction machine is then drive-technically coupled to the second clutch side. To accelerate the second clutch side the electric traction machine is either operated as a generator in order to brake the second clutch side, or it is operated as a motor in order to drive the second clutch side. An electric traction machine of that type can if necessary also be used to synchronize the transmission. Thus, for such an intended purpose of the electric traction machine, the electric traction machine can likewise be understood to be the synchronization device.

To determine the engagement point the following steps can be carried out:
(a) When the clutch is closed, a torque value of the clutch is determined continuously or intermittently. This torque value corresponds to a torque transmitted by the clutch.
(b) For each of these torque values an associated position value of the clutch is determined. This position value corresponds to a clutch position at the moment when the torque value concerned is determined.
(c) From one or more of these torque values and position values, the engagement point of the clutch is determined.

The determination of the position values and the torque values are known to a person familiar with the subject. Such a person also knows in detail how the engagement point is determined from the torque values and the position values. Accordingly, the actual determination can take place in accordance with known methods. For example, when the clutch is being closed it can be recognized that the torque value has exceeded a particular threshold value and the engagement point can be concluded exclusively starting from the position value so determined. For that purpose, a fixed position offset can be deducted from that position value. Or else, a torque gradient can be determined while the clutch is closed, and the engagement point back-calculated therefrom. To determine the engagement point the clutch can be closed in a ramp-like manner. During this, the clutch is in particular closed at a constant closing rate.

The engagement point is determined, in particular, without determining the drag torque of the transmission connected downstream from the clutch. In any case, with a transmission having a low drag torque the drag torque can be negligibly small. Moreover, the determination of the drag torque can be non-trivial. Thus, the method for determining the engagement point can be made more simple.

After the engagement point has been determined, it can be verified. This ensures that the engagement point determined is in fact valid. Preferably, that is also done as part of the proposed method by means of the following steps:
(a) The clutch is brought to a test position which is (just) before the previously determined engagement point. This test position is a clutch position determined on the basis of the engagement point determined, at which the two sides of the clutch—if the engagement point has been determined correctly—should still be (just) rotationally decoupled from one another. For example, the test position is removed from the engagement point determined by a certain clutch travel distance. Thus, depending on whether the clutch was previously closed or open, the clutch is now opened or closed far enough to get to the test position. In particular this takes place immediately after the above-mentioned closing of the clutch.
(b) At the test position, the second clutch side is brought to a particular rotational speed, i.e. either braked or driven (accelerated) up to that speed. Preferably, this too is done by means of the acceleration device. In particular, the second clutch side is braked to a standstill thereby. The transmission coupled to the second clutch side is then (again) idling. In particular, the acceleration device is then disconnected, i.e. the second clutch side is no longer braked or driven, so that the second clutch side can continue rotating freely.
(c) With the first clutch side (still) driven in rotation and while maintaining the test position, it is then determined whether the rotational speed of the second clutch side changes to an unacceptable extent. In particular, during this the rotational speed of the first clutch side is (still) kept constant. In particular, within a specified time the rotational speed of the second clutch side should not exceed or fall below a particular threshold value. Namely this would be the case if the clutch, at the test position, were to transmit a certain torque so that the engagement point would have been incorrectly determined.

If now, in step (c) no rotational speed change, or only a small rotational speed change of the second clutch side takes place, it is accepted that the engagement point determined is valid. In other words, at the test position the clutch correctly transmits no torque, or only very little torque. Then the engagement point determined can be stored in a non-volatile memory for later use. But if in step (c) an excessive rotational speed change takes place, from this it is assumed that the engagement point determined is incorrect. That is to say, in the test position the clutch transmits an unacceptable amount of torque. In that case the process for determining the engagement point can be carried out again in full, from the beginning. Alternatively a certain offset can be added to the engagement point determined to correct it, and the above steps (a) to (c) can then be carried out again for verification using the engagement point corrected in that way. This can happen until no rotational speed change, or only a small rotational speed change takes place in step (c).

The proposed control unit serves to control the clutch and to determine the engagement point of the clutch. This can be a transmission control unit (also called a TCU). The control unit is designed to carry out the proposed method for determining the engagement point of the clutch. Thus, the control unit comprises appropriate interfaces for opening and closing the clutch as required, for actuating the accelerating device correspondingly, and for receiving information about the clutch. This information is evaluated in at least one appropriately designed computing unit of the control unit, and the engagement point is determined thereby.

The computer program product proposed contains stored commands. These commands initiate the sequence of the proposed method for determining the engagement point of the clutch when they run on an appropriate computing unit. The computing unit can be for example a computing unit of the proposed control unit, such as a microcontroller. The computer program product can be any suitable data carrier. The commands can be present in a corresponding software code on the data carrier. When run on the computing unit the software code brings about the sequence of the proposed method, for example in that the computing unit controls or regulates the clutch and the acceleration device as required.

### BRIEF DESCRIPTION OF THE DRAWINGS

Below, the invention is explained in greater detail with reference to figures from which further preferred embodiments and features of the invention can emerge. In the form of schematic representations, the figures show:

FIG. 1: A partial view of a drive-train of a motor vehicle with a drive motor and a multi-stage transmission with a clutch arranged between them,

FIG. 2: Time variations of a rotational speed at a clutch and of an acceleration device of the clutch, and of an actuation condition of an acceleration device.

### DETAILED DESCRIPTION OF THE PREFERRED EMBODIMENTS

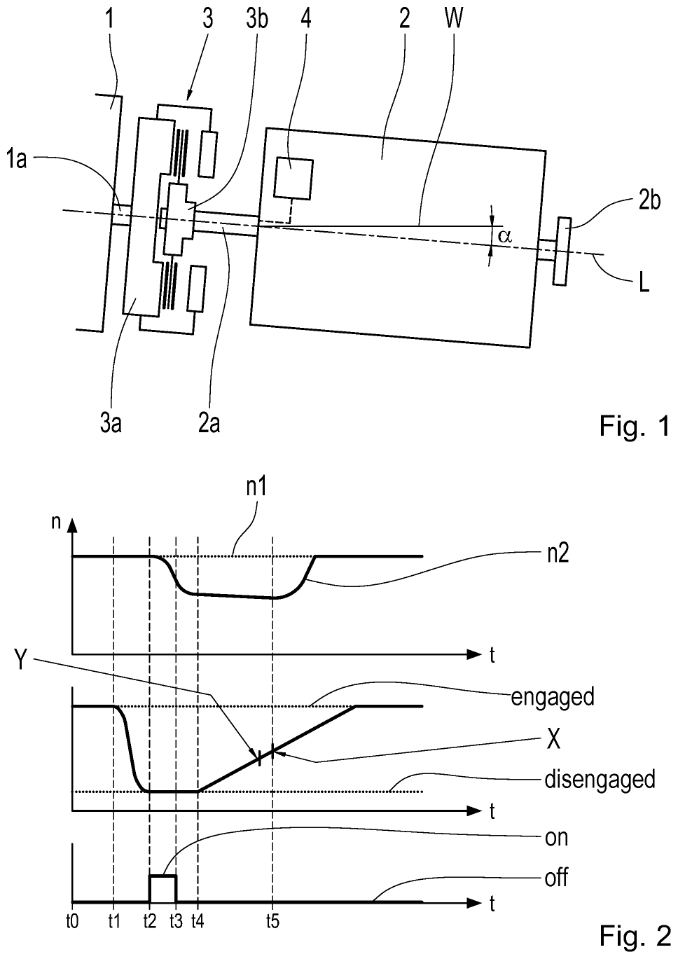

According to FIG. 1 the drive-train of a motor vehicle comprises a drive motor 1, in particular such as an internal combustion engine for propelling the motor vehicle. In addition a multi-stage transmission 2 is provided in the drive-train. In this case it can be an automated change-speed transmission but it can also be an automatic transmission. The transmission 2 has an output shaft 2b on its drive output side, by means of which further drive-output-side components of the drive-train are rotationally coupled. Thus, in a manner already known as such, for example wheels of the motor vehicle can be driven by means of the drive motor 1. On the input side, the transmission 2 has a drive input shaft 2a. In particular the transmission 2 has a low drag torque, so its internal frictional torques are relatively low. Accordingly, the input and output shafts 2a, 2b can be rotated particularly easily.

A frictional clutch 3 is drive-technically connected between the drive motor 1 and the transmission 2. The clutch 3 has two clutch sides 3a, 3b which, depending on the actuation condition of the clutch 3, are rotationally coupled or rotationally decoupled. The clutch 3 is actuated automatically. A driveshaft 1a of the drive motor 1 is coupled rotationally fixed to the first clutch side 3a. The input shaft 2a of the transmission 2 is coupled rotationally fixed to a second clutch side 3b. The clutch 3 can be for example a starter clutch or a converter bridging clutch. When the clutch 3 is open, its clutch sides 3a, 3b are rotationally decoupled from one another. Accordingly, the driveshaft 1a can rotate relative to the input shaft 2a. When the clutch 3 is closed the first and second clutch sides 3a, 3b are rotationally coupled with one another, so that the driveshaft 1a is rotationally coupled to the input shaft 2a.

In such a drive-train it is already known to determine a so-termed engagement point of the clutch 3 automatically. The engagement point corresponds to that clutch position at which the clutch sides 3a, 3b are just in contact with one another without transmitting any substantial force to one another. Thus, at the engagement point of the clutch 3 no substantial torque transmission yet takes place via the clutch 3.

A rotational axis of the clutch sides 3a, 3b and of the shafts 1a, 2a, 2b is indexed L in FIG. 1. When the components 1, 2, 3 are correctly installed, the rotational axis L extends at an angle α relative to the horizontal W. Thus, when a motor vehicle fitted with this drive-train is on a horizontal road surface, the components are inclined relative to the road surface by the angle α.

With such a drive-train it can happed that the determination of the engagement point of the clutch 3 does not take place as it should. This can be attributed to the fact that in practice, one of the clutch sides 3a, 3b is arranged so that it can move axially (i.e. along the rotational axis L) on the shaft 1a, 2a concerned. For example, although the second clutch side 3b can be coupled rotationally fixed to the input shaft 2a, it may be able to be displaced axially on it to some extent. Thus, the second clutch side 3b is arranged in a ‘floating’ manner on the input shaft 2a. Accordingly, when the clutch 3 is closed the second clutch side 3b can come into contact with the first clutch side 3a prematurely. As the clutch continues being closed, the second clutch side 3b is then displaced along the input shaft 2a until the clutch 3 has reached its true engagement point and thereafter begins to grip. If this premature contact takes place while the engagement point of the clutch 3 is being determined, this can be misinterpreted as the actual engagement point. Later actuations of the clutch will be based on this erroneous engagement point, which can result in reduced comfort when the clutch 3 is actuated and/or in increased clutch wear.

The same applies to an interlocking clutch 3. Even if the installed position of the clutch 3 is horizontal, undesired displacement of one of the two clutch sides 3a, 3b may occur, for example due to vibrations in the drive-train or because the motor vehicle is parked on an inclined road. It is thus not absolutely necessary that the components 1, 2, 3 are actually installed inclined by the angle α.

To overcome this problem it is proposed that during the determination of the engagement point the second clutch side 3b that can be displaced on the shaft 2a is selectively accelerated positively or negatively by means of an acceleration device 4. This temporarily increases the friction between the second clutch side 3b and the shaft 2a. Slipping of the second clutch side 3b is thereby prevented or at least delayed until it no longer has any appreciable influence on the determination of the engagement point. Furthermore, as is preferable, there is no need to determine the drag torque of the transmission.

As the acceleration device, for example a transmission brake already present in the transmission in any case would be suitable. This usually serves primarily to synchronize transmission components. By means of it the input shaft 2a can be braked, so that the second clutch side 3b is also braked.

FIG. 2 shows, in the form of three graphs, the time sequence of a preferred embodiment of the proposed method for determining the engagement point of a clutch. In each of the graphs the time t is plotted along the horizontal axis. Below, the method will be explained in the form of an example relating to the drive-train of FIG. 1. Here, for example, the acceleration device 4 brakes the second clutch side 3b. However, the method can also be used with many other drive-trains.

FIG. 2 shows, in the topmost graph, a time variation of a rotational speed n1 of the first clutch side 3a and a time variation of a rotational speed n2 of the second clutch side 3b. Thus, the rotational speed n1 corresponds to the rotational speed of the drive motor 1 and the first clutch side 3a in FIG. 1. The rotational speed n2 corresponds to the rotational speed of the input shaft 3a and the second clutch side 3b in FIG. 1. The rotational speeds n1, n2 can be measured for example by means of a motor rotational speed sensor and a transmission input rotational speed sensor.

In the middle graph FIG. 2 shows a time variation parallel to the above graph, of a clutch position. The clutch position corresponds to the condition of the clutch. The clutch position corresponds to the torque that can be transmitted by the cutch 3. When the clutch position has reached the upper limit, the clutch 3 is fully closed and can then transmit a maximum torque. When the clutch position has reached the lower limit, the clutch 3 is fully open and can then not transmit any torque.

In the lower graph, FIG. 2 shows a time variation parallel to the above two graphs, of an actuation condition of the acceleration device 4. If the acceleration device 4 is switched on, the line of the graph rises above the base line. The second clutch side 3b is then accelerated together with the input shaft 2a. When the acceleration device 4 is switched off, the line of the graph falls back to the base line. The second clutch side 3b can then rotate freely together with the input shaft 2a.

The engagement point is now determined as follows:

At the beginning of the process, i.e. at time t0, the clutch 3 is closed. The first clutch side 3a is driven by the drive motor 1 with a particular constant rotational speed n1 throughout the time interval shown. Throughout the time interval shown, the transmission 2 is idling. Thus, the shifting elements in the transmission 2 are in a shifted condition such that the input shaft 2a is rotationally decoupled from the output shaft 2b.

At time t1 the opening of the clutch 3 begins. The second clutch side 3b is now rotationally decoupled from the first clutch side 3a.

At time t2 the clutch 3 is fully opened. The acceleration device 4 is now actuated, i.e. switched on. Consequently the input shaft 2a together with the second clutch side 3b is braked, i.e. accelerated negatively. Due to this acceleration the friction between the input shaft 2a and the second clutch side 3b increases. This prevents an axial sliding of the second clutch side 3b along the input shaft 2a. Thus, the second clutch side 3b maintains the same axial position it was in while the clutch was previously closed. Accordingly, the rotational speed n2 of the second clutch side 3b falls. It is basically possible for the acceleration device 4 to produce a positive acceleration of the second 3b instead of a negative acceleration, so that it is driving the second clutch side instead of braking it. In that case the rotational speed n2 would increase starting at time t2. In particular, to compensate any dead time of the acceleration device 4 it can be provided that the acceleration device 4 is actuated already during the opening of the clutch 3.

At time t3 the acceleration device 4 is switched off. Thus, the selective braking of the second clutch side 3b ends. Thereafter, the rotational speed n2 still decreases slightly due to the friction in the transmission 2. This switching off of the acceleration device 4 can even be done later if needs be.

At time t4 the process of closing the clutch 3 in a ramp-like manner begins. This closing serves for the actual determination of the engagement point. During it, in a manner known as such, in particular the torque transmitted by the clutch 3 and the clutch position at the time are recorded. For example, during this the moment when the torque transmitted by the clutch 3 exceeds a particular threshold value is recognized. From this, for example by means of a suitable return method the engagement point can be deduced. This eliminates the need to determine the drag torque of the transmission 2.

In FIG. 2 the engagement point is reached at time t5 and the corresponding clutch position determined is X. Starting from there, the clutch 3 therefore starts gripping as closing continues. Correspondingly, from time t5 the rotational speed n2 of the second clutch side 3b starts increasing, since the second clutch side 3b is now increasingly coupled to the driven first clutch side 3a. The clutch position X can now be stored in a non-volatile memory of a control unit for actuating the clutch 3, as the determined engagement point for future actuation processes of the clutch 3. This control unit can be the transmission control unit for actuating the transmission 2. Thereafter, the clutch can be closed completely, although that is not imperatively necessary.

To check the engagement point X just determined, while the first clutch side 3a is still being driven at a constant rotational speed and the transmission 2 is idling, the clutch 3 can now be opened again as far as a test position Y. Starting from the opened clutch 3 the test position Y is located in front of the determined engagement point X. Thus, at the test position Y the two clutch sides 3a, 3b are just rotationally decoupled from one another—assuming that the engagement point X has been determined correctly. The test position Y can be determined for example by deducting or adding a defined offset from or to the previously determined engagement point X. The second clutch side 3b is now braked again by means of the acceleration device 4, in particular down to a standstill. The braking is then terminated. If after this, while the test position Y is maintained, the rotational speed n2 of the second clutch side 3b does not increase or only increases very little over a defined time interval, it can be assumed that the engagement point X has been determined correctly. In that case it can be stored permanently in the non-volatile memory of the control unit for the clutch 3. In that way the engagement point X determined can be verified in a simple manner. In the context of this verification, by means of the acceleration device the second clutch side 3b can also be driven up to a defined rotational speed instead of being braked, i.e. accelerated. Whether it is braked or accelerated for the verification depends on the design of the acceleration device 4 used. For example, if a transmission brake is used as the acceleration device 4, this can only act upon the second clutch side 3b by braking it.

### INDEXES

1 Drive motor
1a Driveshaft
2 Transmission
2a Input shaft
2b Output shaft
3 Clutch
3a First clutch side
3b Second clutch side
4 Acceleration device
L Rotational axis
n, n1, n2 Rotational speed
t, t1 . . . t5 Time point
W Horizontal
X Engagement point
Y Test position
α Angle of inclination

1-10. (canceled)

11. A method for determining an engagement point (X) of a clutch (3), the clutch (3) having first and second clutch sides (3a, 3b), which are rotationally decoupled when the clutch (3) is disengaged and rotationally coupled when the clutch (3) is engaged, the method comprising:
disengaging the clutch (3) and then engaging the clutch (3) in order to determine the engagement point (X), and
during which the first clutch side (3a) is driven in rotation and the second clutch side (3b) is accelerated by an acceleration device (4).

12. The method according to claim 11, further comprising either reducing or increasing a rotational speed (n2) of the second clutch side (3b), with the acceleration device (4), during the acceleration of the second clutch side (3b).

13. The method according to claim 11, further comprising beginning the acceleration of the second clutch side (3b) with the acceleration device (4) either during or after the disengagement (t2) of the clutch and ending the acceleration of the second clutch side (3b) before or during the engagement (t4) of the clutch (3).

14. The method according to claim 11, wherein the clutch (3) is a frictional clutch for a motor vehicle and the clutch (3) is designed to be arranged between a drive motor (1) of the motor vehicle and a transmission (2) of the motor vehicle.

15. The method according to claim 14, wherein when installed in the motor vehicle, arranging the clutch (3) at an inclination (a) relative to a road surface under the motor vehicle.

16. The method according to claim 14, wherein at least one of
the acceleration device (4) is a synchronization device of the transmission (2) for synchronizing at least one shifting element of the transmission (2), and
the acceleration device (4) is an electric traction machine for driving the motor vehicle.

17. The method according to claim 16, wherein the synchronization device is either a transmission brake, or at least one synchronizing ring of the shifting element.

18. The method according to claim 11, further comprising after determining the engagement point (X):
bringing the clutch (3) to a test position (Y) which has been determined on a basis of the engagement point (X) determined and is before the engagement point (X) determined, and then
at the test position (Y), bringing the second clutch side (3b) to a defined rotational speed (n2), by the acceleration device (4), and then
determining whether, while the first clutch side (3a) is being driven in rotation and the second clutch side (3b) stays in the test position (Y), the rotational speed (n2) of the second clutch side (3b) changes to an unacceptable extent.

19. A control unit for actuating a clutch (3) and for determining an engagement point (X) of the clutch (3),
wherein the control unit is designed to carry out the method according to claim 11.

20. A computer program product with stored commands, wherein the commands bring about a sequence of the method according to claim 11 when the computer program product is run on a suitable control unit.

21. A method of determining an engagement point (X) of a clutch (3), the clutch (3) having first and second clutch sides (3a, 3b), which are rotationally decoupled from one another when the clutch (3) is disengaged and are rotationally coupled to one another when the clutch (3) is engaged, the method comprising:
disengaging and then engaging the clutch (3) in order to determine the engagement point (X) of the clutch (3), and
during such disengagement and engagement of the clutch (3), rotationally driving the first clutch side (3a) while accelerating the second clutch side (3b) by an acceleration device (4).
